(19) United States
(12) Patent Application Publication
(10) Pub. No.: US 2010/0075695 A1
(43) Pub. Date: Mar. 25, 2010

(54) SYSTEMS, METHODS, AND DEVICES FOR RETRIEVING LOCAL BROADCAST SOURCE PRESETS

(75) Inventors: Allen P. Haughay, JR., San Jose, CA (US); Michael Ignazio Ingrassia, JR., San Jose, CA (US); Jeffrey Lee, Sunnyvale, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/237,259

(22) Filed: Sep. 24, 2008

(51) Int. Cl. H04W 4/00

(52) U.S. Cl. 455/456.1; 455/550.1

(57) ABSTRACT

A media device including a broadcast receiver that receives broadcast media and a location sensor that determines the location of the media device and generates media device location data. The media device includes a data store that stores at least one data network address for a media data server where the media data server includes a list of broadcast source settings. The data store also stores a preset list of broadcast source settings. The media device also includes a transceiver for: i) sending the media device location data to the media data server and ii) retrieving a location-based list of broadcast source settings associated with the location of the media device. The media device further includes a processor that compares the preset list with the location-based list and determines a local preset list from the retrieved location-based settings that match the preset settings.

### REFERENCE TO RELATED APPLICATIONS

This application is related to the following: U.S. patent application Ser. No. ______, filed on Sep. 24, 2008, having Attorney Docket No. 104677-0298-101 (P6566US1), and entitled “Systems, Methods, and Devices for Providing Broadcast Media from a Selected Source”; U.S. patent application Ser. No. ______, filed on Sep. 24, 2008, having Attorney Docket No. 104677-0302-101 (P6710US1), and entitled “Media Device with Enhanced Data Retrieval Feature”; and U.S. patent application Ser. No. ______, filed on Sep. 24, 2008, having Attorney Docket No. 104677-0300-101 (P6575US1), and entitled “Systems, Methods, and Devices for Associating a Contact Identifier with a Broadcast Source.” The entire contents of the above-referenced applications are incorporated herein by reference.

### BACKGROUND

This invention relates to media devices capable of configuring their local broadcast source presets based on their location.

Traditional media devices, e.g., an MP3 player, typically connect with a headset to enable a user to listen to music. Other media devices may include a display that displays videos. Many types of media devices are portable and have compact form factors to enable efficient handling and use by a user. Certain media devices include a radio broadcast receiver capable of receiving amplitude modulated (AM), frequency modulated (FM), or satellite broadcast media. The media can typically include a song, video, news program, or radio show. Certain media devices, e.g., cellular telephones, include wireless transceivers capable of exchanging data with a public land mobile network (PLMN) or wireless data network that may be linked with the Internet or other data networks. Other media devices are capable of interfacing with personal area networks (PAN), wireless local area networks (WLAN), satellite data networks (SAN), and other data networks including, for example, Wi-fi (802.x) networks.

In addition to providing broadcast media (e.g., songs, video, television programs, and radio shows), certain broadcast media sources can supplement the broadcast media with broadcast media data. The broadcast media data can include media metadata (e.g., information about a particular song) or data about the broadcast source (e.g., the name of the broadcasting radio station).

The Radio Data System (RDS) is a communications standard developed by the European Broadcasting Union (EBU) that enables the transmission of small amounts of broadcast media data using FM radio broadcasts. RDS can send various types of broadcast media data including: time, track title, track artist, and station identification. RDS has been used in Europe and South America since the early 1990s.

The Radio Broadcast Data System (RBDS) is the name for the North American version of RDS, and is also often referred to simply as “RDS.” The North American and European versions are nearly identical. Both RDS versions use a 57 kHz sub carrier to carry broadcast media data at 1187.5 bits per second.

Certain radio receivers include a radio station preset feature whereby a user can program the receiver with a set of pre-selected radio stations. Thus, a user can conveniently and quickly select preferred pre-selected radio stations.

One problem with using existing radio receivers is that, as a radio receiver moves out of its local reception area, the user's preferred local radio stations become unavailable. Thus, the presets of user-selected local radio stations become useless. Accordingly, there is a need for a media device that provides useable presets regardless of the location of the media device.

### SUMMARY

The invention, in various embodiments, addresses deficiencies in the prior art by providing systems, methods and devices that enable a media device to provide a set of user-preferred broadcast source presets based on the location of the media device.

In one aspect, a media device includes a broadcast receiver that receives broadcast media and a location sensor that determines the location of the media device and generates media device location data. The media device includes a data store that stores at least one data network address for a media data server where the media data server includes a list of broadcast source settings. The data store also stores a preset list of broadcast source settings. The media device also includes a transceiver for: i) sending the media device location data to the media data server and ii) retrieving a location-based list of broadcast source settings associated with the location of the media device. The media device further includes a processor that compares the preset list with the location-based list and determines a local preset list from the retrieved location-based settings that match the preset settings.

In one configuration, the broadcast source settings include broadcast radio frequency settings. The broadcast source settings may also include a radio station name, radio station location, radio station range, radio station music style, or the like. In one feature, the location sensor includes a GPS receiver, radio doppler sensor, radio triangulation sensor, or the like. The location sensor may include a wireless network decoder where the decoder identifies a system identifier (SID), network identifier, base station identifier, access point identifier, or the like. The location sensor may determine the media device's location via a fingerprint match where a location fingerprint is determined based on the available radio frequencies that the media device can detect.

The preset list of broadcast source settings may be configured manually by a user. A portion of the preset list of broadcast source settings may be configured automatically by the processor. The processor may employ pattern recognition of a user's broadcast source selections to configure a portion of the preset list. A portion of the preset list of broadcast source settings may be based on the a user's preferred radio station music style. The media may include a video, an image, audio, audio file, a song, music, multimedia, movie, and television data.

In another aspect, a media data server includes a data store that stores a list of broadcast source settings associated with a plurality of broadcast sources and stores location data associated with each of the broadcast sources. The server also includes a data network interface that may receive a query from a media device including the location of the media device and send a list of settings of broadcast sources in the vicinity of the media device. The server further includes a processor that determines the list of broadcast sources in the vicinity of the media device by comparing the location of the media device with the location of the plurality of broadcast radio sources.

In one configuration, the data store stores range data associated with each of the broadcast sources. In another configuration, the processor determines the list of broadcast sources in the vicinity of the media device by comparing the location of the media device with the range data associated with each of the plurality of broadcast radio sources.

In a further aspect, a media device includes a broadcast receiver that receives broadcast media and a location sensor that determines the location of the media device and generates media device location data. The media device also includes a data store that stores a list of a plurality of broadcast radio sources and associated broadcast source settings and stores a preset list of broadcast source settings. The media device further includes a processor that: i) determines a location-based list of broadcast sources in the vicinity of the media device by comparing the location of the media device with the location of the plurality of broadcast radio sources, ii) compares the preset list with the location-based list and ii) determines a local preset list from the retrieved location-based settings that match the preset settings.

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a perspective view of a media device according to an illustrative embodiment of the invention;

FIG. 2 is a view of a media device according to an illustrative embodiment of the invention;

FIG. 3 is a communications topology including a media device according to an illustrative embodiment of the invention;

FIG. 4 shows a simplified functional block diagram of a media device according to an illustrative embodiment of the invention;

FIG. 5 shows a diagram of a distribution system for media and media data according to an illustrative embodiment of the invention;

FIG. 6 shows a diagram of a public land mobile network (PLMN) data distribution system according to an illustrative embodiment of the invention;

FIG. 7 shows a diagram of a wireless access network including an access point according to an illustrative embodiment of the invention;

FIG. 8 is a diagram of a computer processing environment including various applications or routines running within a media device according to an illustrative embodiment of the invention;

FIG. 9A includes a database and/or list user favorite radio presets according to an illustrative embodiment of the invention;

FIG. 9B includes a database and/or list radio station identification information according to an illustrative embodiment of the invention; and

FIG. 10 is a flow diagram of a process for distributing broadcast source preset data according to an illustrative embodiment of the invention.

### DESCRIPTION OF THE INVENTION

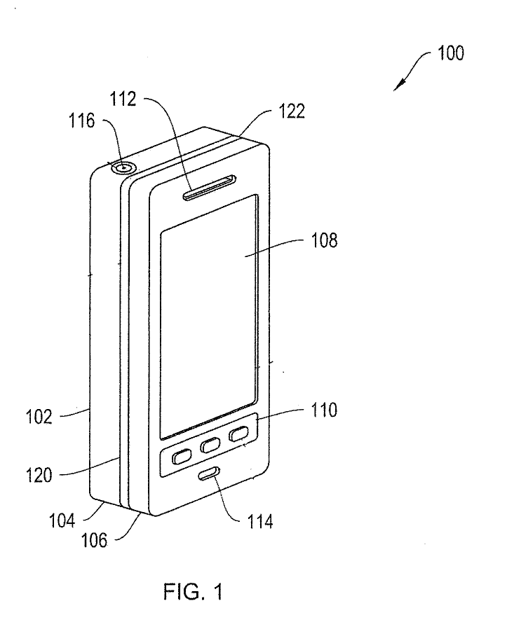

FIG. 1 is a perspective view of a media device 100 according to an illustrative embodiment of the invention. The device 100 includes a housing 102, a first housing portion 104, a second housing portion 106, a display 108, a keypad 110, a speaker housing aperture 112, a microphone housing aperture 114, a headphone jack 116, and frame sidewall 122. In certain embodiments, the frame sidewall 122 is the exposed portion of a frame residing within or adjacent to the housing 102 that provides structural support for the media device 100 and various internal components.

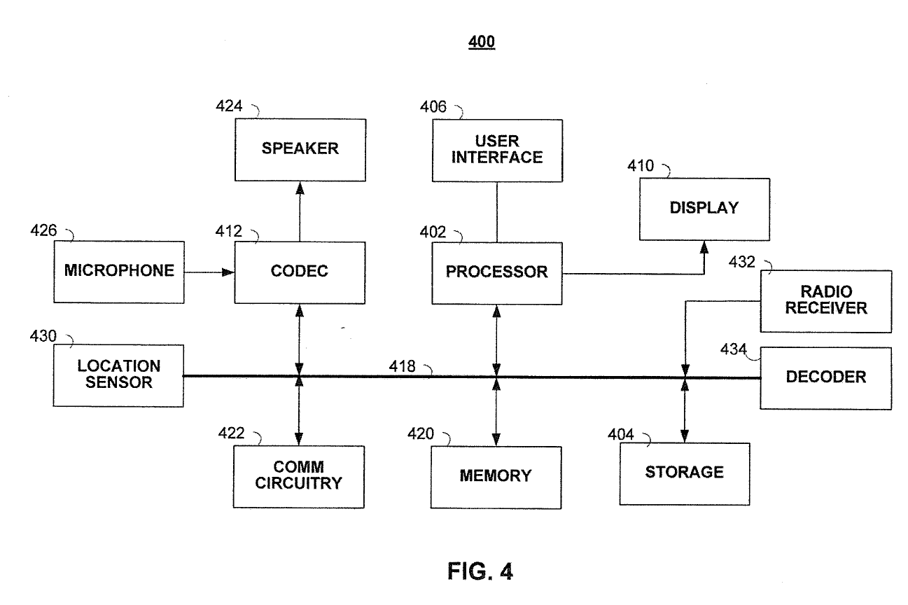

In one embodiment, the housing 102 includes a first housing portion 104 and a second housing portion 106 that are fastened together and/or to the frame sidewall 122 to encase various components of the media device 100. The housing 102 and its housing portions 104 and 106 may include polymer-based materials that are formed by, for example, injection molding to define the form factor of the media device 100. In one embodiment, the housing 102 surrounds and/or supports internal components such as, for example, a display 108, one or more circuit boards having integrated circuit components, internal radio frequency (RF) circuitry, an internal antenna, a speaker, a microphone, a hard drive, a processor, and other components. Further details regarding certain internal components are discussed herein with respect to FIG. 4. The housing 102 provides for mounting of a display 108, keypad 110, external jack 116, data connectors, or other external interface elements. The housing 102 may include one or more housing apertures 112 to facilitate delivery of sound, including voice and music, to a user from a speaker within the housing 102. The housing 102 may include one or more housing apertures 114 to facilitate the reception of sounds, such as voice, for an internal microphone from a device user.

Personal computing devices and/or media devices of this type may include a touchscreen control, such as a Pronto made available by Royal Philips Electronics of the Netherlands or a GPS receiver made available by Garmin International, Inc. of Olathe, Kans. In certain embodiments, the display 108 includes a graphical user interface (GUI) to enable a user to interact with the device 100. The personal computing device 100 may also include an image sensor such as a camera capable of capturing photographic images and/or video images.

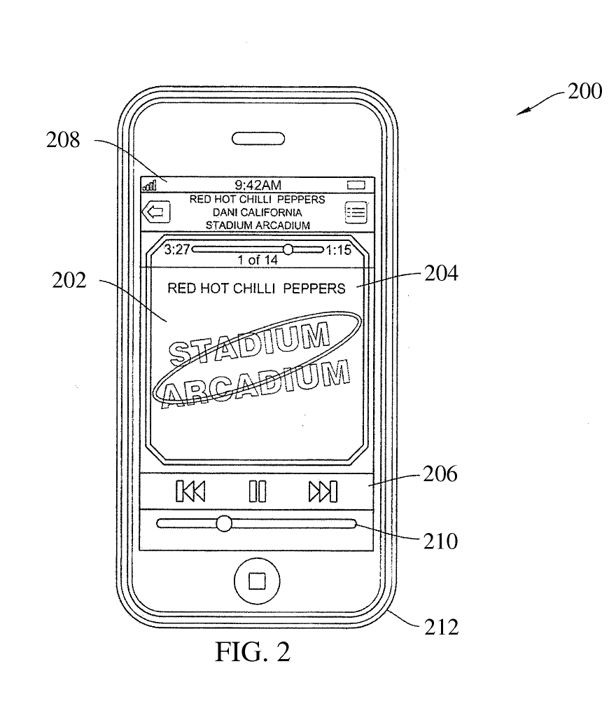

FIG. 2 is a view of another personal media device 200 according to an illustrative embodiment of the invention. The media device 200 includes a display 202 showing a status bar 208 and video image 204, which may include, for example, a music video, a movie, video clip, or like video images. In one embodiment, a GUI of the display 202 includes an interface 206 that enables the media device 200 user to play, pause, fast forward, reverse, or monitor, via a slider 210, the progress of the video displayed on the display 202 or audio being played by the media device 200. The media device 200 includes a housing base 212.

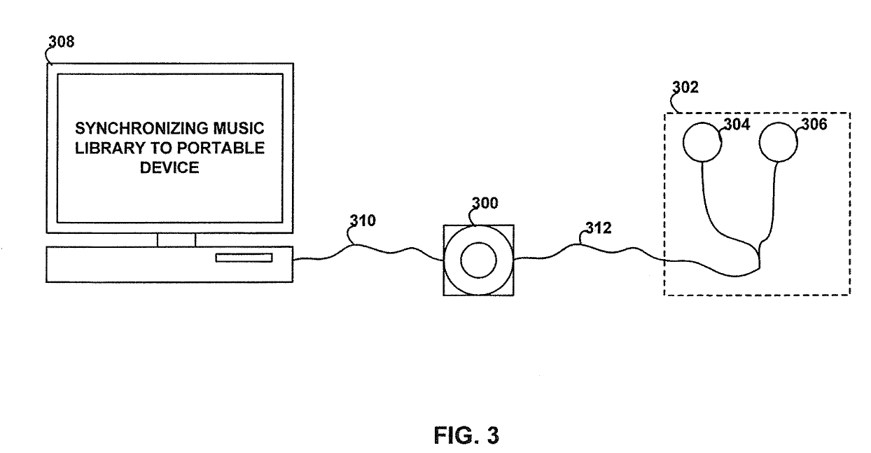

FIG. 3 shows a communications topology including a computer 308, media device 300, and a headset 302. Media device 300 may communicate with computer 308 via communications channel 310. Media device 300 may communicate with the headset 302 via communications channel 312. In one embodiment, communications channel 312 is a wired communication channel. Alternatively, the communications channel 312 may be wireless.

Media device 300 may take any form. For example, media device 300 may be a portable media player such as a portable music player. Media device 300 may also include, for example, a mobile telephone that may play downloaded media. Media may be downloaded directly to the media device 300 or may be downloaded to computer 308 and transferred to the media device 300 via communications channel 310.

The media device 300 may include a wireless communications device such as a cellular telephone, satellite telephone, cordless telephone, personal digital assistant (PDA), pager, portable computer, or any other device capable of wireless communications. In fact, FIG. 2 shows an exemplary cellular telephone version of a broad category of media device 300. The media device 300 may be compact, portable, mobile, personal, and/or transportable.

The media device 300 may also be integrated within the packaging of other devices or structures such as a vehicle, video game system, appliance, clothing, helmet, glasses, wearable apparel, stereo system, computer system, entertainment system, or other portable devices. In certain embodiments, the media device 300 may be docked or connected to a wireless (e.g., a wi-fi docking system) and/or radio enabling accessory system (e.g., AM/FM or satellite radio receiver) that provides the media device 300 with short-range communicating functionality and/or radio reception capability. Alternative types of media devices 300 may include, for example, a media player such as an iPod®, iPod® Nano, iPod® Shuffle, or Apple® iPhone available by Apple Inc., of Cupertino, Calif., pocket-sized personal computers such as an iPAQ® Pocket PC available by Hewlett Packard Inc., of Palo Alto, Calif. and any other device capable of communicating wirelessly (with or without the aid of a wireless enabling accessory system).

In certain embodiments, the media device 300 may synchronize with, for example, a remote computing system or server, e.g., computer 308, to receive media (using either wireless or wireline communications paths). Wireless syncing enables the media device 300 to transmit and receive media and data without requiring a wired connection. Media may include, without limitation, sound or audio files, music, video, multi-media, and digital data, in streaming and/or discrete (e.g., files and packets) formats.

During synchronization, a host system, e.g., device 308, may provide media to a client system or software application embedded within the media device 300. In certain embodiments, media and/or data is “downloaded” to the media device 300. In other embodiments, the media device 300 is capable of uploading media to a remote host or other client system.

The headset 302 may be utilized to provide an audio functionality associated with media device 300. The headset 302 may include speakers 304 and 306 as well as a microphone.

FIG. 4 shows a simplified functional block diagram of a media device 400 according to an illustrative embodiment of the invention. The block diagram provides a generalized block diagram of a computer system such as may be employed, without limitation, by the media devices 100, 200, and 300. The media device 400 may include a processor 402, storage device 404, user interface 406, display 610, CODEC 612, bus 618, memory 620, communications circuitry 622, a speaker or transducer 624, a microphone 426, a location sensor 430, a radio receiver 432, a radio receiver decoder 434, a speaker 424, and communications circuitry to facilitate communications with a headset 302, other media device, or other system via a communications network. Processor 402 may control the operation of many functions and other circuitry included in media device 400. Processor 402 may drive display 410 and may receive user inputs from the user interface 406.

Storage device 404 may store media (e.g., music and video files), software (e.g., for implanting functions on device 400), preference information (e.g., media playback preferences), lifestyle information (e.g., food preferences), personal information (e.g., information obtained by exercise monitoring equipment), transaction information (e.g., information such as credit card information), word processing information, personal productivity information, wireless connection information (e.g., information that may enable media device to establish wireless communication with another device), subscription information (e.g., information that keeps tracks of podcasts or television shows or other media that a user subscribes to), radio station broadcast source information, and any other suitable data. Storage device 404 may include one more storage mediums, including for example, a hard-drive, permanent memory such as ROM, semi-permanent memory such as RAM, or cache.

Memory 420 may include one or more different types of memory which may be used for performing device functions. For example, memory 420 may include cache, ROM, and/or RAM. Bus 418 may provide a data transfer path for transferring data to, from, or between at least storage device 404, memory 420, and processor 402. Coder/decoder (CODEC) 412 may be included to convert digital audio signals into an analog signals for driving the speaker 424 to produce sound including voice, music, and other like audio. The CODEC 412 may also convert audio inputs from the microphone 426 into digital audio signals. The CODEC 412 may include a video CODEC for processing digital and/or analog video signals.

User interface 408 may allow a user to interact with the media device 400. For example, the user interface 408 can take a variety of forms, such as a button, keypad, dial, a click wheel, or a touch screen. Communications circuitry 422 may include circuitry for wireless communication (e.g., short-range and/or long range communication). For example, the wireless communication circuitry may be Wi-Fi enabling circuitry that permits wireless communication according to one of the 802.1x standards. Other wireless network protocols standards could also be used, either in alternative to the identified protocols or in addition to the identified protocol. Other network standards may include Bluetooth, the Global System for Mobile Communications (GSM), code division multiple access (CDMA), and long-term evolution (LTE) based wireless protocols. Communications circuitry 422 may also include circuitry that enables the media device 400 to be electrically coupled to another device (e.g., a computer or an accessory device) and communicate with that other device.

In one embodiment, the media device 400 may be a portable computing device dedicated to processing media such as audio and video. For example, the media device 400 may be a media device such as media player (e.g., MP3 player), a game player, a remote controller, a portable communication device, a remote ordering interface, an audio tour player, or other suitable media device. The media device 400 may be battery-operated and highly portable so as to allow a user to listen to music, play games or video, record video or take pictures, communicate with others, and/or control other devices. In addition, the media device 400 may be sized such that it fits relatively easily into a pocket or hand of the user. By being handheld, the media device 400 (or media devices 100, 200, and 300) is relatively small and easily handled and utilized by its user and thus may be taken practically anywhere the user travels.

The media device 400 may employ a location sensor 430 to enable the media device to determine its geographic location in support of location-based services and other services. The location sensor 430 may include a global position system (GPS) receiver. The location sensor 430 may include one or more radio receivers that perform radio doppler and/or triangulation sensing to determine the media device 400 location. In certain embodiments, the location sensor 430 may be integrated with the communications circuitry 422. In one embodiment, the location sensor 430 may include a data decoder such as decoder 434 that decodes a source identifier broadcast by a radio source (e.g., radio station identifier or cellular network system identifier (SID)).

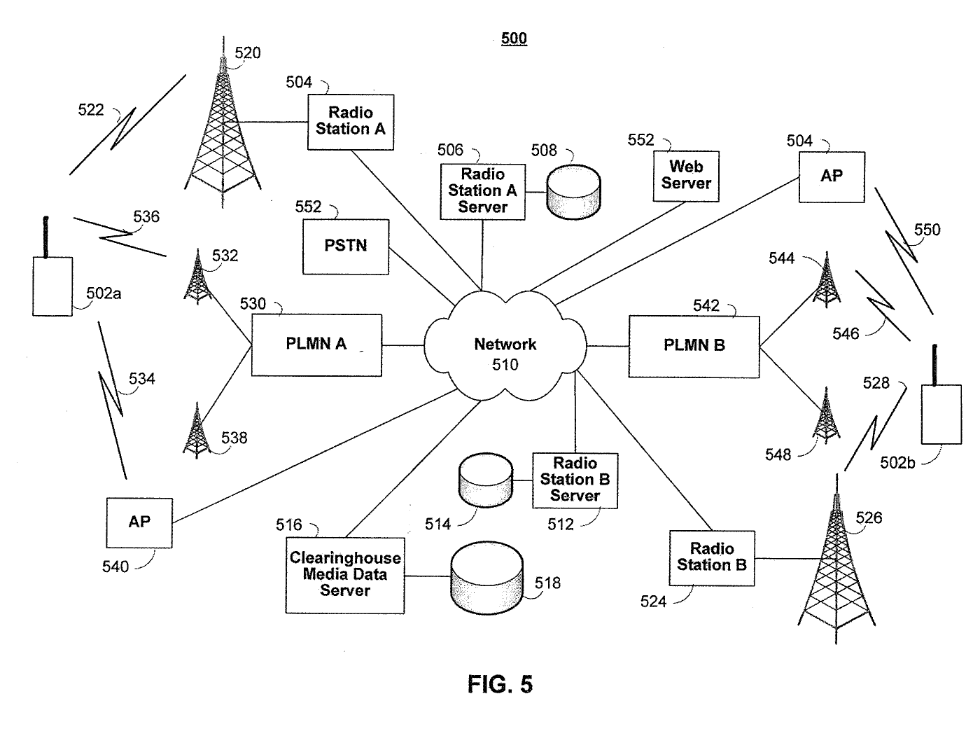

FIG. 5 shows a diagram of a media distribution system 500 according to an illustrative embodiment of the invention. The media distribution system 500 includes a media device 502, a broadcast radio station 504, a broadcast radio station 524, a public land mobile network (PLMN) 530, a PLMN 542, an access point (AP) 540, and AP 504, a data network 510, a public switched telephone network (PSTN) 552, and a clearinghouse server 516. The network 510 may include the Internet. The radio station 504 may include a radio station tower 520 that facilitates the broadcast of a broadcast radio signal 522 to a plurality of media devices including media device 502. Also, the radio station 524 may include a radio station tower 526 that facilitates the broadcast of a broadcast radio signal 528 to a plurality of media devices including media device 502.

The broadcast radio signal may be, without limitation, frequency modulated (FM) or amplitude modulated (AM). The interfaces 522 and 528 may operate in an AM frequency band of about 500-1500 kHz. The interfaces 522 and 528 may operate in an FM and/or television frequency band of about 54-1600 MHz. The interfaces 522 and 528 may operate and any number of frequency bands such as, for example, a satellite frequency band. The radio station 504 may be associated with a radio station server 506 that includes a database 508 for storing media and/or media data. The radio station 524 may be associated with a radio station server 512 that includes a database 514 for storing media and/or media data.

The PLMNs 530 and 542 may include a cellular telephone network. The PLMNs 530 and 542 may utilize a plurality of cellular radio towers 532, 538, 544, and 548 respectively. The media device 502 may exchange data and other communications with the PLMN 530 and/or 542 via a wireless communications channel 536 and/or 546 respectively. The media device 502 may exchange data and other communications with the AP 540 and/or AP 504 via a wireless communications channel 534 and 550 respectively. The clearinghouse media data server 516 may include a database 518 for storing media and/or media data.

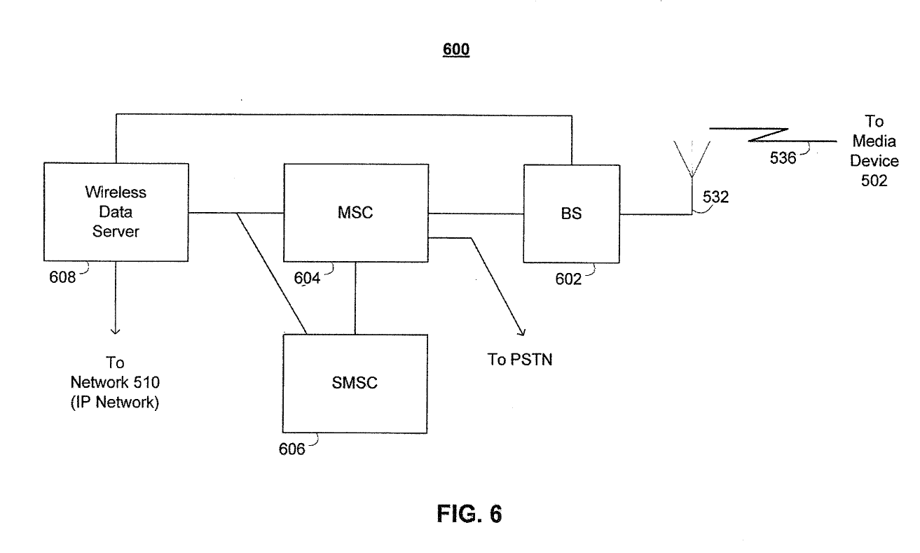

FIG. 6 shows a diagram of a public land mobile network (PLMN) 600 according to an illustrative embodiment of the invention. A PLMN may include a wireless telecommunications network and/or a cellular telephone network such as a Global System for Mobile communications (GSM), cdma2000 system, ANSI-136 TDMA system, LTE, and like wireless communications networks. These networks may also provide data communications services such as Evolution-data only (EV-DO), General Packet Radio Service (GPRS), wireless application protocol (WAP), cellular digital packet data (CDPD), and like wireless data services.

PLMN networks are generally referred to as cellular networks because they employ a frequency re-use architecture in which wireless access channels are grouped into geographically-located cells and sectors. The size of each cell depends on the output power of the network base station (BS) transceiver, e.g., BS 602, associated with each cellular tower 532 and cell. Each access channel uses a certain frequency band in one geographic cell that is re-used in another cell, geographically separated from the first cell, by another access channel where the likelihood of interference is minimized.

These networks also use a centralized switch or server such as the mobile switching center (MSC) 604 to enable a wireless device to move from cell to cell while maintaining a persistent data connection. In the United States, cellular and Personal Communications Service (PCS) networks operate in the licensed commercial 800-900 Mhz and 1900-2100 Mhz ranges. Access data channels, however, may be bandwidth limited to 30 khz, 200 khz, or 1.24 Mhz depending on the wireless air interface standard used.

PLMN networks primarily provide voice communications while also providing relatively low rate data communications (e.g., 9.6-140 kbps). PLMN networks such as the Global System for Mobile Communications (GSM) and cdma2000 provide a Short Message Service (SMS) that enables telephone users to send relatively short, e.g., about 160 bytes, messages to other cellular telephones or to traditional electronic mail (e-mail) accounts within land-based IP networks.

A Short Message Server Center (SMSC) 606 typically coordinates with the MSC 604 to distribute SMS messages to cellular telephones and/or media devices 502. The SMSC may also interface with a wireless data server 608 to send SMS messages with destination addresses, e.g., e-mail addresses, external to the PLMN 600. The SMSC may include a mail server and/or other functionality to convert SMS messages to the proper e-mail format if necessary. Alternatively, the wireless data server may include a mail server such as a POP and/or Exchange server to facilitate the delivery of e-mail messages to and from the PLMN 600.

SMS messages may be transmitted over the air interface 120 via the traffic and/or control channels of the PLMN 600 network. While SMS messages are typically limited to about 160 bytes in length, longer text messages may be sent to or received by a media device 502. This may be performed by breaking a larger message into multiple SMS messages for delivery and then re-assembling the multiple SMS messages into the original message upon receipt. Multimedia message services (MMS) may also be employed having messages that include text, video, pictures, and audio.

Recently, PLMN providers have launched higher bandwidth data networks such as cdma2000 Evolution Data Only (EVDO) networks that provide up to 2 Mbps and Third Generation GSM (3GSM) networks that provide approximately 300 kbps data rates. These higher rate data services may employ point-to-point (PPP), simple IP and/or mobile IP (MIP) protocols to more efficiently interface with traditional IP networks such as network 510 and/or the Internet. The wireless data server 608 may function as a cdma2000 and/or GPRS Packet Data Server Node (PDSN), MIP Home Agent, MIP Foreign agent, wireless data gateway, and like systems to facilitate data communications with an external data network such as the network 510.

Using circuit-switched and/or packet-switched data services, the PLMN 600, 530, and 542 enables a media device 502 to act like a network interface to another data network such as the Internet. Thus, media device 502 may employ any of the applications and features of a standard workstation and/or home personal computer, subject to the processing speed, power, and memory constraints of a compact and mobile device. For example, the media device 502 may utilize a WWW browser employing HTML, WML, XML, and like markup languages to facilitate access to a remote web server, e.g., server 552, 506, 512, and/or 516, via the network 510. The media device 502 may utilize certain applications that enable the exchange of data with remote data servers connected to the network 510. Data may be transported to and from the network 510 via the wireless data server 608. In these instances, the wireless data server 608 exchanges data with the BS 602. The BS 602, in turn, transmits data to and/or receives data from the media device 502 via one or more data traffic channels on the air interface 536 or 546.

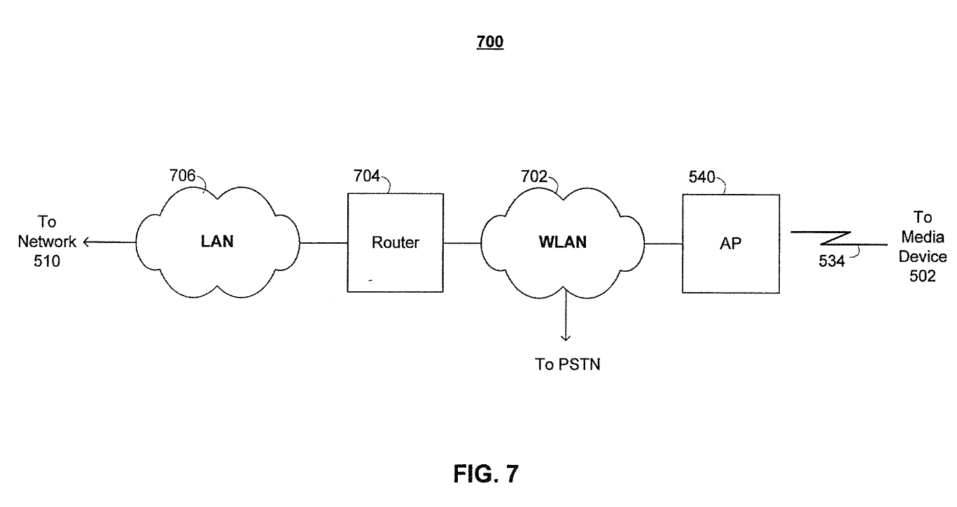

FIG. 7 shows a diagram of a wireless access network 700 including an access point (AP) 540 according to an illustrative embodiment of the invention. A wireless access network may include any wireless network that facilitates communications from one communications device to another or to another network such as the Internet. Typical wireless access networks include 802.11, WiFi, WiMAX, Bluetooth, proprietary wireless LANs, wide area wireless networks, and like wireless access networks.

The wireless access network 700 includes an AP 540, a wireless LAN (WLAN) 702, router 704, and local area network (LAN) 706. The LAN may be connected to network 510 via one or more data networks. The WLAN 702 may be connected to the PSTN 552 via one or more network interfaces. The AP 540 may connect with one or more media devices 502. WLAN networks, such as WLAN 702, employ wireless APs 540 to communicate with multiple wireless devices, e.g., media device 502, simultaneously via a set of wireless access channels.

While the wireless access network 700 may not support SMS messaging as with the PLMN 600, the wireless access network 700 is capable of supporting relatively high data rate communications between a media device 502 and the network 510. Furthermore, the wireless access network 700 can support higher layer protocols such as TCP/IP, HTTP, and UDP, which enable the use of a web browser and other applications at the media device 502.

Returning to FIG. 5, in operation, the media device 502 may move from one geographic location in the vicinity of certain wireless communications infrastructure elements to another geographic location in the vicinity of other wireless communications infrastructure elements. For example, FIG. 5 refers to media device 502 as media device 502a while the device is in the vicinity of radio station 504, but then refers to media device 502 as media device 502b when the device is in the vicinity of radio station 524. In other embodiments, the terms 502a and 502b can refer to different media devices.

As discussed previously, a media device 502 may include a broadcast radio receiver, e.g., radio receiver 432, that enables the media device 502 to receive media from a plurality of radio stations, e.g., radio station 504, within its vicinity. The media device 502 may include the capability to enable a user to configure a set of favorite radio stations and/or radio station frequencies so that the user can conveniently tune the broadcast radio receiver 432 to a favorite radio station.

In addition to the radio receiver 432, the media device 502 may include a data transceiver as part of its communications circuitry 422 to facilitate the exchange of data with a PLMN, e.g., PLMN 530, a wireless access network, e.g., via AP 540, or another like wireless data network. In certain embodiments, the media device 502 may utilize a data transceiver to supplement broadcast media and/or media data received from a radio station such as radio stations 504 and 524. In one embodiment, the media device 502 is capable of querying a clearinghouse media data server 516 via a wireless data network (e.g., PLMN or wireless access network) to obtain media and/or media data. A clearinghouse server 516 may include one or more data servers and systems that perform a network-based services via, for example, the Internet. One example of a clearinghouse media data server 512 is the iTunes® music downloading service, made available by Apple Inc. of Cupertino, Calif. Media data may include metadata and/or data about or related to media. For example, media data may include an image such as album cover art related to a song. Media data may also include information related to a broadcast source of the media such as the name of a radio station playing a song. In certain embodiments, the media device 502 can retrieve media and/or media data from a radio station server 504 and/or its associated database 508, the clearinghouse server 516 and/or its associated database 518, a remote web server 552, and any other data source in communication with the network 510. The broadcast sources 504 and 524 may utilize the RDS system to provide a limited amount of information such as a song title, artist name, 64—character text, a station call sign, radio station music categories (e.g., rock, country, classical, and so on), and other information.

One problem with existing broadcast radio receivers is that their local radio station presets become unusable as the radio receiver moves outside of the broadcast range of the preset local radio stations. The present invention advantageously addresses this problem by enabling a media device to sense its location and dynamically adjust and/or configure its radio presets based on its location and, thereby, provide continuously provide its user with usable broadcast source presets.

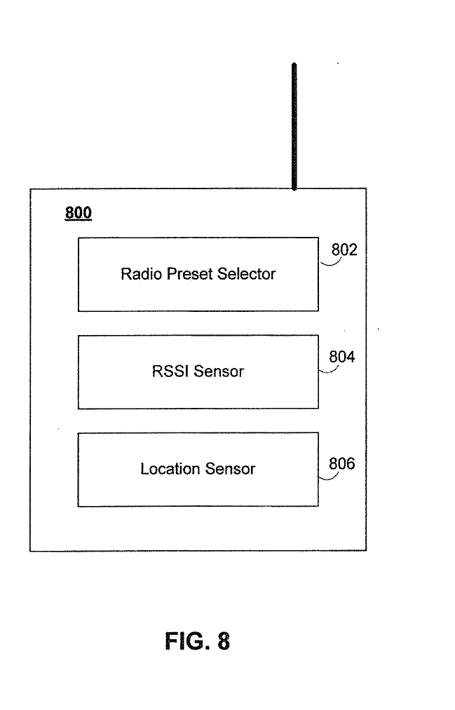

FIG. 8 is a diagram of a computer processing environment including various functions running within a media device 800 according to an illustrative embodiment of the invention. The media device 800 may include a radio preset selector application 802, a received signal strength selector 804, and a location sensor application 806.

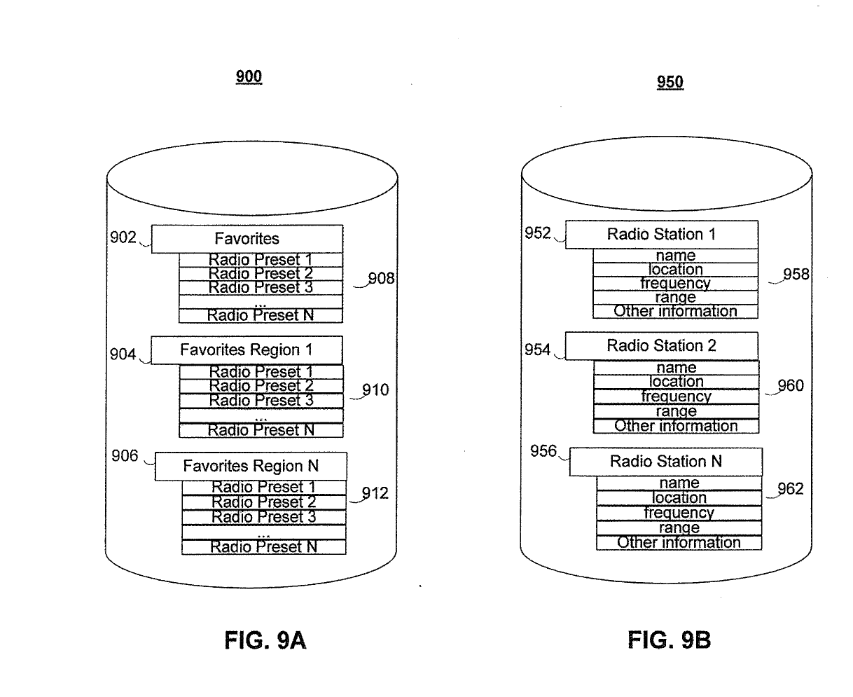

In one embodiment, the media device 800 and/or 502 includes a broadcast receiver that receives broadcast media and a location sensor 806 that determines the location of the media device 800 and generates media device location data. The media device 800 may include a data store, such as data store 900 of FIG. 9A, that may store a data network address for a media data server, such as server 516, where the media data server 516 includes a list of broadcast source settings. The data store 900 may also store a preset list of broadcast source settings associated with, for example, broadcast sources 504 and 524. The media device 800 may also include a transceiver that sends media device location data to the media data server 516 and retrieves a location-based list of broadcast source settings associated with the location of the media device 800. The media device 800 may include a processor, such as processor 402, that utilizes the radio preset selector application 802 to compare the preset list with the location-based list and determine a local preset list from the retrieved location-based settings that match the preset settings. Thus, as the media device 800 travels from one geographic region to another geographic region, the media device 800 can automatically configure its radio station and/or broadcast source presets to provide usable presets to its user regardless of the media device 800 location.

The broadcast source settings may include broadcast radio frequency settings. The broadcast source settings may also include a radio station name, radio station location, radio station range, radio station music style, or the like. The location sensor may includes a GPS receiver, radio doppler sensor, radio triangulation sensor, or the like. The location sensor may include a wireless network decoder where the decoder identifies a system identifier (SID), network identifier, base station identifier, access point identifier, RDS information, or the like. A network, access point, and/or base station identifier can provide adequate location information in certain embodiments.

FIG. 9A includes a database and/or list 900 of user favorite radio presets 902 according to an illustrative embodiment of the invention. Each favorite radio preset 902 may include a set of preset radio stations 908. In one embodiment, a user may configure the list 900 with a favorites list 902 that can be compared with the list 950 to determine a local preset list that is then made available by the media device 800 based on its location. In another embodiment, the user may configure the list 900 with preset favorite lists based on different geographic regions 904 and 906. Thus, the media device 800 may use the location sensor application 806 to determine the location of the media device 800 to determine which of the favorite preset lists 904 and 906 to make available to the user.

FIG. 9B includes a database and/or list 950 of radio station identification information according to an illustrative embodiment of the invention. The list 950 may be maintained by a clearinghouse server 516, web server 552, or national database of radio stations with associated radio station data. In one embodiment, the list 950 includes a list associated with a plurality of broadcast sources 952, 954, and 956. For each broadcast source, the database 950 includes associated data 958, 960, and 962. In certain embodiments, the data and/or settings include the name of the radio station, location, broadcast frequency, broadcast range, music category and/or style (e.g., rock, country, jazz, and the like), and other information.

The preset list of broadcast source settings may be configured manually by a user. However, a portion of the preset list of broadcast source settings may be configured automatically by the selector application 802. The selector application 802 may employ pattern recognition of a user's broadcast source selections to configure a portion of the preset list. The pattern recognition may include an statistical analysis of the user's broadcast source selection patterns. A portion of the preset list of broadcast source settings may be based on the a user's preferred radio station music style.

In another embodiment, a media data server 516 includes a data store 518 and/or 950 that stores a list of broadcast source settings 958, 960, and 962 that are associated with a plurality of broadcast sources 952, 954, and 956. The server 516 stores location data associated with each of the broadcast sources, e.g., radio station 504 and 524. The server 516 may also include a data network interface that may receive a query from a media device 800 including the location of the media device 800. The server 516 may then send to the media device 800 a list of settings of broadcast sources in the vicinity of the media device. The server 516 may also include a processor that determines the list of broadcast sources in the vicinity of the media device by comparing the location of the media device 800 with the location of the plurality of broadcast radio sources.

The data store 950 may store range data associated with each of the broadcast sources 952, 954, and 956. The server 800 may determine the list of broadcast sources in the vicinity of the media device 800 by comparing the location of the media device 800 with the location and range data associated with each of the plurality of broadcast radio sources 952, 954, and 956.

In another embodiment, instead of querying a remote server 516 for radio station information, the media device 800 may store the radio station information internally such that the database 950 is included within the media device 800. Thus, in one embodiment, the selector application 802 determines a location-based list of broadcast sources in the vicinity of the media device by comparing the location of the media device 800 with the location of the plurality of broadcast radio sources as listed in its own database 950, compares the preset list with the location-based list, and determines a local preset list from the retrieved location-based settings that match the preset settings.

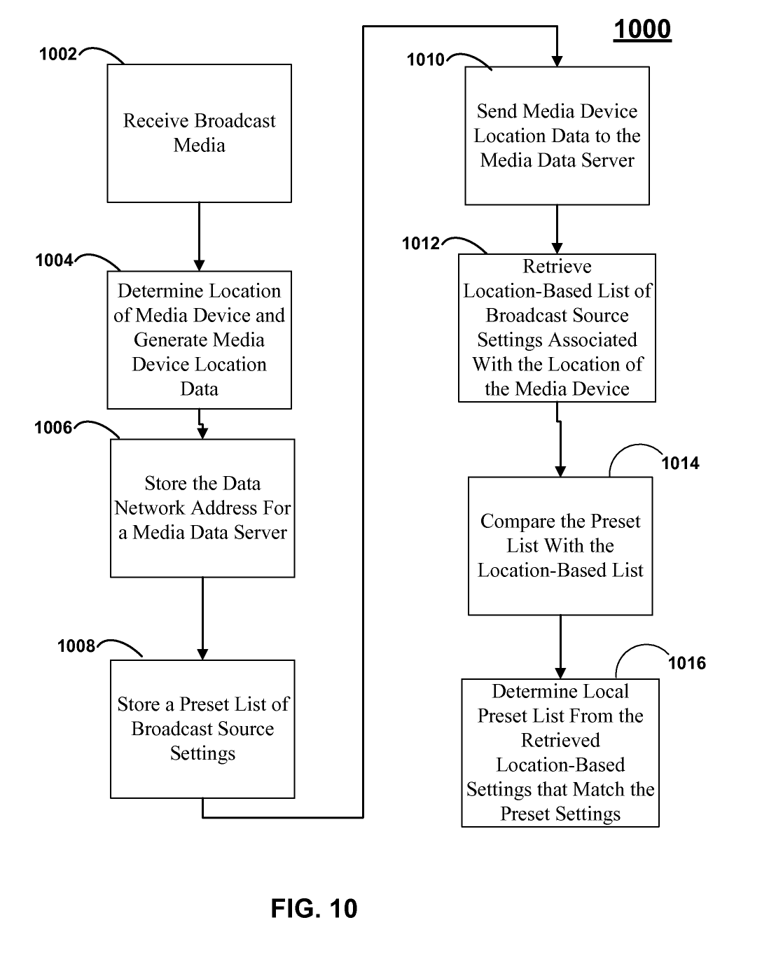

FIG. 10 is a flow diagram of a process 1000 for distributing broadcast source preset data according to an illustrative embodiment of the invention. First, a media device 502 receives broadcast media (Step 1002). Then, the media device 502 determines its location and generates media device location data (Step 1004). The media device 502 stores a data network address of a media data server 516 (Step 1006). The media device 502 stores a preset list of broadcast source settings within a database 900 (Step 1008). The media device 502 then sends the media device location data to the media data server 516 (Step 1010). The media device 502 retrieves a location-based list of broadcast source settings associated with the location of the media device 516 (Step 1012). The media device 502 compares the preset list, such as favorites 902 list 908, with the location-based list derived from the list of database 950 (Step 1014). The media device 502 determines its local preset list from the retrieved location-based settings that match the preset settings 902 (Step 1016).

Persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

What is claimed is:

1. A media device comprising:
a broadcast receiver for receiving broadcast media,
a location sensor for determining the location of the media device and generating media device location data, and
a data store for storing: i) at least one data network address for a media data server, the media data server including a list of broadcast source settings and ii) a preset list of broadcast source settings,
a transceiver for: i) sending the media device location data to the media data server and ii) retrieving a location-based list of broadcast source settings associated with the location of the media device, and
a processor for: i) comparing the preset list with the location-based list and ii) determining a local preset list from the retrieved location-based settings that match the preset settings.

2. The device of claim 1, wherein the broadcast source settings include broadcast radio frequency settings.

3. The device of claim 1, wherein the broadcast source settings include at least one of a broadcast radio frequency setting, a radio station name, radio station location, radio station range, and radio station music style.

4. The device of claim 1, wherein the location sensor includes at least one of a GPS receiver, radio doppler sensor, radio triangulation sensor.

5. The device of claim 1, wherein the location sensor includes a wireless network decoder, the decoder identifying at least one of a system identifier (SID), network identifier, base station identifier, and access point identifier.

6. A method for determining broadcast source presets for a media device comprising:
receiving broadcast media,
determining the location of the media device and generating media device location data, and
storing at least one data network address for a media data server, the media data server including a list of broadcast source settings,
storing a preset list of broadcast source settings,
sending the media device location data to the media data server,
retrieving a location-based list of broadcast source settings associated with the location of the media device,
comparing the preset list with the location-based list, and
determining a local preset list from the retrieved location-based settings that match the preset settings.

7. The method of claim 6, wherein the broadcast source settings include broadcast radio frequency settings.

8. The method of claim 6, wherein the broadcast source settings include at least one of a broadcast radio frequency setting, a radio station name, radio station location, radio station range, and radio station music style.

9. The method of claim 6, wherein determining the location of the media device includes using at least one of a GPS receiver, radio doppler sensor, radio triangulation sensor.

10. The method of claim 6, wherein determining the location of the media device includes using a wireless network decoder, the decoder identifying at least one of a system identifier (SID), network identifier, base station identifier, and access point identifier.

11. A media data server comprising:
a data store for i) storing a list of broadcast source settings associated with a plurality of broadcast sources and ii) storing location data associated with each of the broadcast sources,
a data network interface for i) receiving a query from a media device including the location of the media device and ii) sending a list of settings of broadcast sources in the vicinity of the media device,
a processor for determining the list of broadcast sources in the vicinity of the media device by comparing the location of the media device with the location of the plurality of broadcast radio sources.

12. The server of claim 11, wherein the data store stores range data associated with each of the broadcast sources.

13. The server of claim 11, wherein the processor determines the list of broadcast sources in the vicinity of the media device by comparing the location of the media device with the range data associated with each of the plurality of broadcast radio sources.

14. A media device comprising:
a broadcast receiver for receiving broadcast media,
a location sensor for determining the location of the media device and generating media device location data, and
a data store for storing: i) a list of a plurality of broadcast radio sources and associated broadcast source settings and ii) a preset list of broadcast source settings,
a processor for: i) for determining a location-based list of broadcast sources in the vicinity of the media device by comparing the location of the media device with the location of the plurality of broadcast radio sources, ii) comparing the preset list with the location-based list and ii) determining a local preset list from the retrieved location-based settings that match the preset settings.

15. The device of claim 14, wherein the broadcast source settings include broadcast radio frequency settings.

16. The device of claim 14, wherein the broadcast source settings include at least one of a broadcast radio frequency setting, a radio station name, radio station location, radio station range, and radio station music style.

17. The device of claim 14, wherein the location sensor includes at least one of a GPS receiver, radio doppler sensor, radio triangulation sensor.

18. The device of claim 14, wherein the location sensor includes a wireless network decoder, the decoder identifying at least one of a system identifier (SID), network identifier, base station identifier, and access point identifier.

19. The device of claim 14, wherein the preset list of broadcast source settings is configured manually by a user.

20. The device of claim 14, wherein a portion of the preset list of broadcast source settings is configured automatically by the processor.

21. A computer-readable medium that stores instructions executable by a media device to cause the media device to perform a method for determining broadcast source presets, the method comprising:
receiving broadcast media,
determining the location of the media device and generating media device location data, and
storing a list of a plurality of broadcast radio sources and associated broadcast source settings,
storing a preset list of broadcast source settings,
determining a location-based list of broadcast sources in the vicinity of the media device by comparing the location of the media device with the location of the plurality of broadcast radio sources,
comparing the preset list with the location-based list, and
determining a local preset list from the retrieved location-based settings that match the preset settings.

22. The method of claim 21, wherein the broadcast source settings include broadcast radio frequency settings.

23. The method of claim 21, wherein the broadcast source settings include at least one of a broadcast radio frequency setting, a radio station name, radio station location, radio station range, and radio station music style.

24. The method of claim 21, wherein determining the location of the media device includes using at least one of a GPS receiver, radio doppler sensor, radio triangulation sensor.

25. The method of claim 21, wherein determining the location of the media device includes using a wireless network decoder, the decoder identifying at least one of a system identifier (SID), network identifier, base station identifier, and access point identifier.

26. The method of claim 21, wherein the preset list of broadcast source settings is configured manually by a user.

27. The method of claim 21, wherein a portion of the preset list of broadcast source settings is configured automatically by the processor.

28. The method of claim 27, wherein the processor employs pattern recognition of a user's broadcast source selections.

29. The method of claim 28, wherein a portion of the preset list of broadcast source settings is based on the a user's preferred radio station music style.

30. The method of claim 21, wherein the media includes a video, an image, audio, audio file, a song, music, multimedia, movie, and television data.
